(19) United States
(12) Patent Application Publication
(10) Pub. No.: US 2026/0366420 A1
(43) Pub. Date: Nov. 19, 2026

(54) THREE-DIMENSIONAL CORE-BASED IN-SITU STRESS MEASUREMENT SYSTEM AND METHOD USING MULTI-SOURCE DATA

(71) Applicant: Institute of Geomechanics, Chinese Academy of Geological Sciences, Beijing (CN)

(72) Inventor: Chongyuan Zhang, Beijing (CN)

(21) Appl. No.: 19/266,109

(22) Filed: Jul. 10, 2025

(30) Foreign Application Priority Data
May 19, 2025 (CN) 202510637555.5

(51) Int. Cl. E21B 49/00; E21B 47/06

(52) U.S. Cl. CPC E21B 49/006; E21B 47/06

(57) ABSTRACT

The present application relates to the technical field of in-situ stress measurement, in particular relates to a three-dimensional core-based in-situ stress measurement system and method using multi-source data. The method includes: obtaining wellbore wall failure information and identifying the failure type in the wellbore wall failure information; selecting multiple segments of core samples based on the wellbore wall failure information, and determining the overlying pressure parameters based on each core samples, and performing rock mechanics experiment on the core samples to generate rock mechanical parameters, including a Poisson's ratio, a Young's modulus, a uniaxial compressive strength value and a tensile strength value.

### CROSS-REFERENCE TO RELATED APPLICATIONS

The present application claims priority to Chinese patent application No. 202510637555.5, titled “three-dimensional core-based in-situ stress measurement system and method using multi-source data”, filed on May 19, 2025, the entire contents of which are incorporated herein by reference.

### TECHNICAL FIELD

The present application relates to the technical field of in-situ stress measurement, in particular relates to a three-dimensional core-based in-situ stress measurement system and method using multi-source data.

### BACKGROUND

The in-situ stress state is determined by the direction of the in-situ stress and the magnitude of the stress, the magnitude of the stress includes the longitudinal stress and the horizontal principal stress. The longitudinal stress is usually obtained by integrating the density of the overlying rock strata, which is relatively easy to measure. However, the accurate determination of the maximum and minimum principal stresses in the horizontal direction, especially the maximum principal stress, still faces many technical challenges, especially in deep formation conditions. Traditional in-situ stress measurement methods mainly include hydraulic fracturing, imaging logging, stress relief, core hysteresis elastic recovery (ASR), and seismic wave method. Although drilling methods such as hydraulic fracturing are often used for field measurements, the maximum principal stress value measured is greatly affected by factors such as formation heterogeneity and fracture development, and the error is high. Core methods such as ASR have strict requirements for sample processing accuracy and complex experiments. However, the seismic law relies on natural earthquakes or artificial excitation, and its application scenarios are limited.

In recent years, multi-source fusion measurement methods based on core mechanics experiments and wellbore wall imaging have gradually emerged. This method combines the analysis of wellbore wall failure characteristics with core mechanical parameters, supplemented by differential loading experiments to derive the maximum and minimum principal stress differences, and constructs a stress polygon model and failure mode to invert the stress state, which has strong practicability and adaptability. However, the existing methods still have the problems of insufficient utilization of wellbore wall information, unclear judgment of principal stress, low efficiency of multi-source data fusion, and weak representativeness of samples, which restrict their wide application in deep complex structural regions.

### SUMMARY

Based on this, it is necessary for the present application to provide a three-dimensional core-based in-situ stress measurement system and method using multi-source data, to solve at least one of the above-mentioned technical problems.

In order to achieve the above purpose, a three-dimensional core-based in-situ stress measurement method using multi-source data, which includes:
Step S1: obtaining wellbore wall failure information, and identifying a failure type in the wellbore wall failure information; selecting multiple segments of core samples based on the wellbore wall failure information, and determining overlying pressure parameters based on the multiple core samples;
Step S2: performing rock mechanics experiment on each core sample, to generate rock mechanical parameters, wherein rock mechanical parameters comprise a Poisson's ratio, a Young's modulus, a uniaxial compressive strength value and a tensile strength value;
Step S3: marking a smooth core sample from a variety of core samples based on the failure type, and performing Diameter Core Deformation Analysis (DCDA) experiments on the smooth core sample by the Poisson's ratio and the Young's modulus to obtain a difference between a maximum stress and a minimum stress;
Step S4: constructing a stress polygon model based on the overlying pressure parameters; constructing a wellbore wall failure model based on the failure type; using a stress polygon model and the wellbore wall failure model to plan a two-dimensional constraint region, and performing a multi-source coupling constraint principal stress;
Step S5: performing a strength constitutive constraint principal stress based on the failure type by using the uniaxial compressive strength value and the tensile strength value; and
Step S6: performing topological visualization on the multi-source coupling constraint principal stress and the strength constitutive constraint principal stress, and regionally overlapping the difference between the maximum stress and the minimum stress and a topological visualization result to determine a numerical range of a maximum principal stress and a minimum principal stress.

The present application improves the accuracy and adaptability of in-situ stress determination by systematization, multi-source fusion, and has significant beneficial effect. Firstly, the wellbore wall failure information is fully utilized to improve the ability to identify the formation stress state, and the problem of low utilization rate of wellbore wall information in the traditional method is avoided. Secondly, the representativeness of the samples is enhanced by the selection and comparative analysis of multiple types of core samples, so as to improve the reliability of the experimental data. Combined with the Diameter Core Deformation Analysis (DCDA), the difference between the maximum and minimum stress is extracted, which effectively avoids the problem of large error in a single measurement method, and is especially suitable for deep structural regions with strong stratigraphic heterogeneity. And the induced stress polygon model and the wellbore wall failure model form a two-dimensional constraint system, and are combined with the constitutive relationship of rock strength value to achieve the deep integration of multi-source data, which greatly improves the accuracy and physical consistency of the principal stress derivation. Finally, the topological visualization method is used to carry out the region overlap analysis, which not only enhances the intuitiveness and interpretability of the stress identification process, but also effectively improves the stability and accuracy of the determination of the maximum principal stress and minimum principal stress range, which provides a more reliable and generalizable technical path for the study of deep in-situ stress.

The present application further provides a three-dimensional core-based in-situ stress measurement system using multi-source data, which is used to execute the above-mentioned three-dimensional core-based in-situ stress measurement method using multi-source data. The three-dimensional core-based in-situ stress measurement system using multi-source data includes:
a failure identification module, for obtaining wellbore wall failure information, and identifying a failure type in the wellbore wall failure information; selecting multiple segments of core samples based on the wellbore wall failure information, and determining overlying pressure parameters based on the multiple core samples;
a mechanical testing module, for performing rock mechanics experiment on each core sample, to generate rock mechanical parameters, wherein rock mechanical parameters comprise a Poisson's ratio, a Young's modulus, a uniaxial compressive strength value and a tensile strength value;
a stress difference measurement module, for marking a smooth core sample from a variety of core samples based on the failure type, and performing Diameter Core Deformation Analysis (DCDA) experiments on the smooth core sample by the Poisson's ratio and the Young's modulus to obtain a difference between a maximum stress and a minimum stress;
a stress modeling module, for constructing a stress polygon model based on the overlying pressure parameters; constructing a wellbore wall failure model based on the failure type; using a stress polygon model and the wellbore wall failure model to plan a two-dimensional constraint region, and performing a multi-source coupling constraint principal stress;
a range constraint module, for performing a strength value constitutive constraint principal stress based on the failure type by using the uniaxial compressive strength value and the tensile strength value; and
an intersection inversion module, for performing topological visualization on the multi-source coupling constraint principal stress and the strength constitutive constraint principal stress, and regionally overlapping the difference between the maximum stress and the minimum stress and a topological visualization result to determine a numerical range of a maximum principal stress and a minimum principal stress.

The present application integrates multi-source data and multi-dimensional constraint means by modular design, significantly improves the scientificity and practicability of in-situ stress determination, and has many beneficial effects. Firstly, the failure identification module improves the recognition depth and utilization efficiency of wellbore wall information, so that the failure characteristics can be accurately classified and the sample selection can be guided, and the representativeness of the data and the accuracy of the overlying pressure estimation are enhanced. The mechanical test module ensures the comprehensiveness of core parameter acquisition and the standardization of experiments, and lays a solid foundation for subsequent analysis. The stress difference measurement module provides a reliable reference for stress differences by identifying smooth cores and performing DCDA experiments, avoiding the uncertainties of traditional methods in heterogeneous or fractured formations. The stress modeling module uses a two-dimensional constraint method to solve the principal stresses in a multi-source coupling, which significantly improves the adaptability of the model to the complex geological environment and the accuracy of the principal stress judgment. The range constraint module further introduces the strength constitutive relation to limit the stress boundary, which makes the stress solution more physically constrained and of practical engineering significance. Finally, the intersection inversion module enhances the intuitiveness and reliability of the results through topology visualization and overlapping analysis of stress differences, effectively realizes the comprehensive determination of the maximum and minimum principal stress range, and provides efficient and generalizable technical support for the stress analysis of deep structural regions.

### BRIEF DESCRIPTION OF THE DRAWINGS

The other features, purposes and advantages of the present application will become more apparent by reading the detailed description of the non-restrictive embodiment with reference to the following drawings:

FIG. 1 is a flowchart of a three-dimensional core-based in-situ stress measurement method using multi-source data of the present application.

FIG. 2 is a detailed step-by-step flow schematic diagram of step S1 in FIG. 1.

FIG. 3 is a detailed step-by-step flow diagram of step S2 in FIG. 1.

FIG. 4 shows a constrained range determined for inducing tensile fractures in figure (a), and a constrained range determined for caving in figure (b).

### DETAILED DESCRIPTION OF THE EMBODIMENTS

The technical method of the present application is clearly and completely described below in conjunction with the accompanying drawings, and obviously, the embodiments described are part embodiments of the present application, not all embodiments. Based on the embodiments in the present application, all other embodiments obtained by the technician to whom the art belongs without making creative labor belong to the scope of protection of the present application.

In addition, the drawings are only illustrative illustrations of the present application and are not necessarily drawn to scale. The same reference marks in the figure indicate the same or similar parts, so that repeated descriptions of them will be omitted. Some of the block diagrams shown in the drawings are functional entities that do not necessarily have to correspond to physically or logically independent entities. Functional entities can be implemented in software form, in one or more hardware modules or integrated circuits, or in different network and/or processor approaches and/or microcontroller approaches.

It should be understood that, although the terms “first”, “second”, etc., may be used here to describe the individual units, they should not be limited by these terms. These terms are used only to distinguish one unit from another. For example, without departing from the scope of the exemplary embodiment, the first unit may be referred to as the second unit And similarly the second unit can be called the first unit. The term “and/or” as used here includes any and all combinations of one or more of the associated items listed.

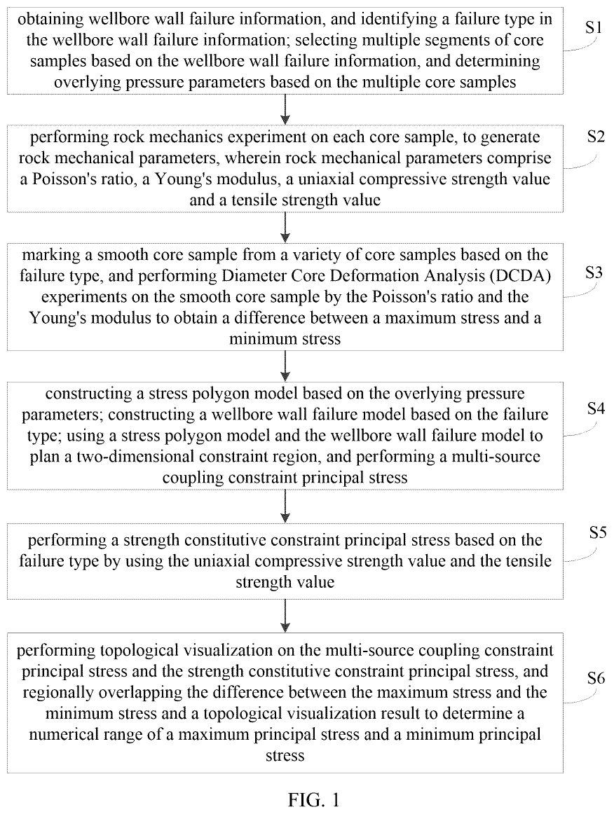

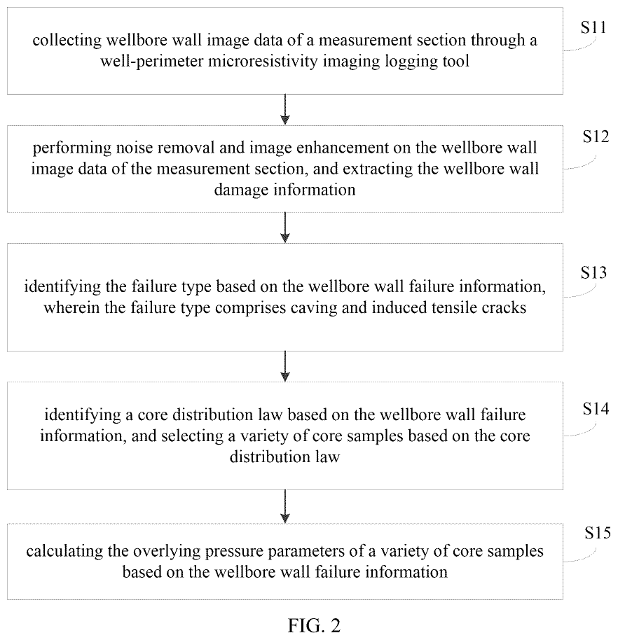

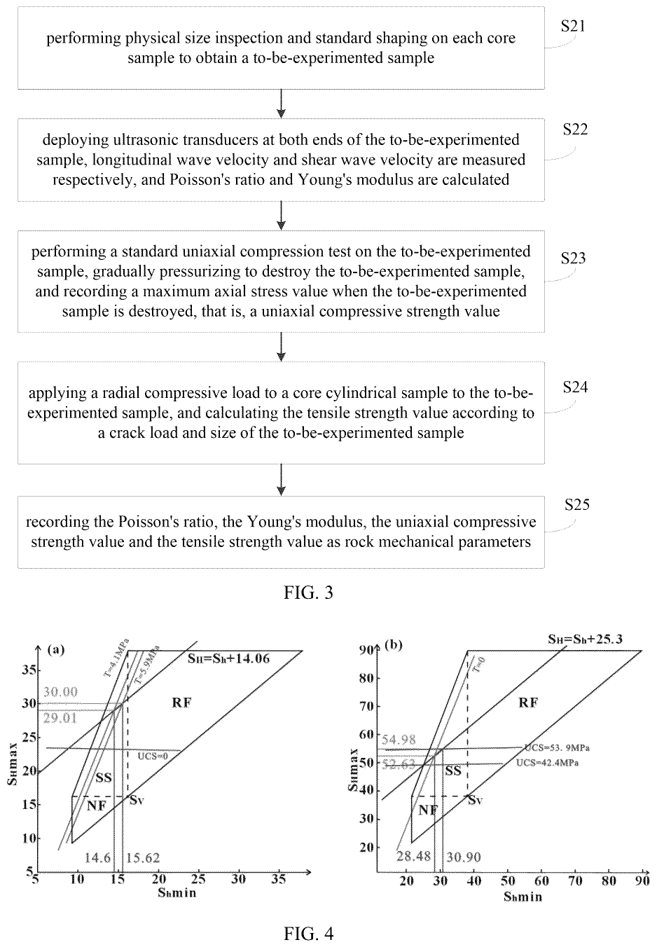

In order to achieve the above-mentioned purpose, refer to FIG. 1 to FIG. 4, the present application provides a three-dimensional core-based in-situ stress measurement method using multi-source data, and described method includes:
Step S1: obtaining wellbore wall failure information, and identifying a failure type in the wellbore wall failure information; selecting multiple segments of core samples based on the wellbore wall failure information, and determining overlying pressure parameters based on the multiple core samples;
Step S2: performing rock mechanics experiment on each core sample, to generate rock mechanical parameters, wherein rock mechanical parameters comprise a Poisson's ratio, a Young's modulus, a uniaxial compressive strength value and a tensile strength value;
Step S3: marking a smooth core sample from a variety of core samples based on the failure type, and performing Diameter Core Deformation Analysis (DCDA) experiments on the smooth core sample by the Poisson's ratio and the Young's modulus to obtain a difference between a maximum stress and a minimum stress;
Step S4: constructing a stress polygon model based on the overlying pressure parameters; constructing a wellbore wall failure model based on the failure type; using a stress polygon model and the wellbore wall failure model to plan a two-dimensional constraint region, and performing a multi-source coupling constraint principal stress;
Step S5: performing a strength constitutive constraint principal stress based on the failure type by using the uniaxial compressive strength value and the tensile strength value; and
Step S6: performing topological visualization on the multi-source coupling constraint principal stress and the strength constitutive constraint principal stress, and regionally overlapping the difference between the maximum stress and the minimum stress and a topological visualization result to determine a numerical range of a maximum principal stress and a minimum principal stress.

In the embodiment of the present application, FIG. 1 is a flowchart of a three-dimensional core-based in-situ stress measurement method using multi-source data of the present application, and in this example, described three-dimensional in-situ stress measurement method of core based on multi-source data includes:
Step S1: obtaining wellbore wall failure information, and identifying a failure type in the wellbore wall failure information; selecting multiple segments of core samples based on the wellbore wall failure information, and determining overlying pressure parameters based on the multiple core samples.

In the embodiment of the present application, at first the wellbore wall image data of the target measurement section of 300-500 meters depth range is collected by the well-perimeter micro-resistivity imaging logging tool with 1 millimeter longitudinal resolution, then the noise is removed from the wellbore wall image data by using the wavelet transform method, and the histogram equalization technology is adopted to realize image enhancement, and the signal-to-noise ratio after enhancement is increased by at least 20%, and then the grayscale gradient analysis is used to extract the wellbore wall damage feature information, including the failure position, the shape and the azimuth angle. According to the extracted feature information, the failure type is identified by determining the geometric characteristics of the failure morphology (if irregular blocky spalling occurs, it is determined as caving; if regular parallel longitudinal linear patterns appear, it is determined as induced tensile fractures). Subsequently, based on the lithological variation characteristics and failure distribution patterns shown in the wellbore wall image data, at least three representative core samples are selected from each failure zone, with a diameter of 25.4 mm and a length of 50.8 mm, to ensure that the sampling location corresponds strictly to the failure region. Finally, the core density value ρ(h) on the depth profile is obtained by using the acoustic logging data, and the density measurement accuracy is controlled within ±0.05 g/cm³, combined with the gravitational acceleration constant g (9.8 m/s²) and the depth of the measuring well H, the overlying pressure parameters are calculated by the integral formula

$${S}_{V} = {\int }_{0}^{H} ρ ( h ) g d h ,$$

the depth profile is discretized into 500 depth points during the calculation, and the core density value is determined by cubic spline interpolation at each depth point, and then the Simpson integral method is used for numerical integration operation, to obtain an overlying pressure parameter value accurate to 0.1 MPa.
Step S2: performing rock mechanics experiment on each core sample, to generate rock mechanical parameters, wherein rock mechanical parameters comprise a Poisson's ratio, a Young's modulus, a uniaxial compressive strength value and a tensile strength value.

In the embodiment of the present application, at first, the selected core sample is checked by physical dimensions to ensure that the diameter deviation does not exceed ±0.5 mm and the length deviation does not exceed ±1.0 mm, standard shaping treatment is carried out by a high-precision diamond cutting machine to ensure that the parallelism deviation of the two end surfaces is less than 0.02 mm and the perpendicularity deviation is less than 0.05 mm, to form a standard cylindrical to-be-experimented sample. Subsequently, P-wave (longitudinal wave) and S-wave (shear wave) ultrasonic transducers are installed at both ends of the to-be-experimented sample, the frequency is set to 500 kHz, the ultrasonic detector is used to transmit and receive the wave signal with a sampling accuracy of 5 ns, the wave propagation time is recorded, and the longitudinal wave velocity Vp and the shear wave velocity Vs are calculated to be accurate to 10 m/s and the Poisson's ratio ν is calculated according to the formula

$$v = \frac{{V}_{p}^{2} - 2 {V}_{s}^{2}}{2 ( {V}_{p}^{2} - {V}_{s}^{2} )}$$

to the accuracy of 0.01, and the Young's modulus E is calculated according to the formula

$$E = ρ {V}_{s}^{2} \cdot \frac{3 {V}_{p}^{2} - 4 {V}_{s}^{2}}{{V}_{p}^{2} - {V}_{s}^{2}}$$

to the accuracy of 0.1 GPa; Then, the to-be-experimented sample is placed in the MTS815 hydraulic servo loading system for a standard uniaxial compression test, the loading rate is controlled at 0.5 MPa/s, and the axial pressure is continuously applied until the sample is in the event of macroscopic failure, the maximum axial stress value at the time of failure is recorded as the uniaxial compressive strength value σ_{c}, and the measurement accuracy is controlled ±0.5 MPa; Then, the Brazilian splitting test method is used, the to-be-experimented sample is placed in a special fixture, the radial compressive load is applied, the loading rate is controlled at 200N/s until the sample is split along the axial direction, and the tensile strength value Sₜ is calculated according to the formula

$${S}_{t} = \frac{2 P}{π DL} ,$$

where P is the rupture load value (unit: N) and D is the sample diameter (unit: mm), L is the length of the sample (unit: mm), and the calculation result is accurate to 0.1 MPa; Finally, the measured Poisson's ratio ν, the Young's modulus E (unit: GPa), uniaxial compressive strength value σ_{c} (unit: MPa) and tensile strength value Sₜ (unit: MPa) are summarized and recorded as the rock mechanical parameters of the rock sample.
Step S3: marking a smooth core sample from a variety of core samples based on the failure type, and performing Diameter Core Deformation Analysis (DCDA) experiments on the smooth core sample by the Poisson's ratio and the Young's modulus to obtain a difference between a maximum stress and a minimum stress.

In the embodiment of the present application, the core sample with surface smoothness reaching Ra≤0.02 mm is screened out from a variety of core samples according to the failure type (caving or induced tensile cracks), and the KEYENCE LK-G10 laser displacement meter is used to measure 24 points at 15° intervals along the circumferential direction of the cross-section of the smooth core sample, with the measurement accuracy controlled within ±0.001 mm. Subsequently, the original diameter distribution data of the smooth core sample under no external force (i.e., zero stress state) are recorded with a precision of 0.001 mm. Then, the MTS816 hydraulic servo loading system is used to apply an axial pressure to the smooth core sample. The loading value is set to 20 MPa, the loading rate is controlled at 0.2 MPa/s, and it is kept constant for 120 seconds to ensure sufficient deformation of the sample. After the loading state is stable, the laser displacement meter is used again to measure the diameter changes of the smooth core sample at the same 24 angular positions to obtain the deformed radial dimension data (d₁, d₂, . . . , d₂₄) with a precision of 0.001 mm. Then, through data analysis, the maximum (corresponding angle θₘₐₓ) and minimum (corresponding angle θₘᵢₙ) diameters after loading are determined, and whether the two angles differ by approximately 90°±5° (to validate the anisotropic characteristics of the stress field) is verified. Subsequently, the Young's modulus E value (unit: GPa) and the Poisson's ratio ν are substituted into the Diameter Core Deformation Analysis (DCDA) formula

$$Δ S = {S}_{max} - {S}_{min} = \frac{E}{1 + v} \frac{{d}_{max} - {d}_{min}}{{d}_{0}}$$

to calculate the difference ΔS (unit: GPa) between the maximum and minimum stresses, the unit consistency needs to be kept during the calculation, and d₀ is the average of the 24 measurement points. Throughout the measurement process, the environmental temperature is controlled at 23±2 °C and the laboratory relative humidity is controlled at 50%±10%. The calculation results should be accurate to 0.1 MPa, and the azimuth angles θₘₐₓ and θₘᵢₙ correspond to the maximum and minimum deformations. The entire DCDA experiment is repeated three times for each smooth core sample and its arithmetic mean is taken as the final result.
Step S4: constructing a stress polygon model based on the overlying pressure parameters; constructing a wellbore wall failure model based on the failure type; using a stress polygon model and the wellbore wall failure model to plan a two-dimensional constraint region, and performing a multi-source coupling constraint principal stress.

In the embodiment of the present application, at first, the RFT repeated bottom layer tester is used to collect pore pressure P_{P} data at every 20 meter interval in the target measurement section, and the acquisition pressure range is 0-70 MPa, and the accuracy is controlled at ±0.1 MPa, and the average value is taken as a representative value after the collection data is removed by filtering wave processing. Then, based on the overlying pressure parameter S_{V}, combined with the friction coefficient μ and the value of 0.75, three sets of inequalities are substituted:

$$\frac{{S}_{V} - {P}_{P}}{{S}_{h} - {P}_{P}} \leq {[ {( {u}^{2} + 1 )}^{\frac{1}{2}} + μ ]}^{2}$$

$$\frac{{S}_{H} - {P}_{P}}{{S}_{h} - {P}_{P}} \leq {[ {( {μ}^{2} + 1 )}^{\frac{1}{2}} + μ ]}^{2}$$

$$\frac{{S}_{H} - {P}_{P}}{{S}_{V} - {P}_{P}} \leq {[ {( {μ}^{2} + 1 )}^{\frac{1}{2}} + μ ]}^{2}$$

Constructing a stress polygon model,

$${[ {( {u}^{2} + 1 )}^{\frac{1}{2}} + μ ]}^{2}$$

is calculated to obtain a value of approximately 3.1, and the set of inequalities is solved to obtain the preliminary numerical ranges for the maximum principal stress S_{H} and the minimum principal stress Sₕ. Then, a wellbore wall failure model is constructed based on the failure type. The specific operations are as follows: recording the drilling fluid pressure P_{W} (measured by a drilling fluid pressure gauge, an accuracy of ±0.5 MPa), and the effective stress around the wellbore wall in cylindrical coordinates is expressed as:

$${σ}_{r}^{′} = {P}_{W} - {P}_{P}$$

$${σ}_{θ}^{′} = {σ}_{xx} + {σ}_{yy} - 2 ( {σ}_{xx} - {σ}_{yy} ) cos 2 θ - 4 {τ}_{xy} sin 2 θ - {P}_{W} - {P}_{P}$$

$${σ}_{z}^{′} = {σ}_{zz} - v [ 2 ( {σ}_{xx} - {σ}_{yy} ) cos 2 θ - 4 {τ}_{xy} sin 2 θ ] - {P}_{P}$$

$${τ}_{θ z} = 2 ( - {τ}_{xz} sin θ + {τ}_{yz} cos θ )$$

$${τ}_{r θ} = 0$$

$${τ}_{r z} = 0$$

When the failure type is caving, the shear failure criterion

$${σ}_{1}^{′} = {σ}_{c} + {tan}^{2} ( 45 ° + \frac{φ}{2} ) {σ}_{3}^{′}$$

is applied. The internal friction angle is taken as 30°, σ_{c} is the uniaxial compressive strength value. When the failure type is induced tensile fracture, the tensile failure criterion is applied, which is the tensile strength value. When the failure type is induced tensile fracture, the tensile failure criterion

$${σ}_{3}^{′} = - {S}_{t}$$

is applied, Sₜ is the tensile strength value. Then, in the MATLAB R2023a environment, a two-dimensional cartesian coordinate system is established, the horizontal axis represents the minimum principal stress Sₕ (unit: MPa) and the vertical axis represents the maximum principal stress S_{H} (unit: MPa). The constraint conditions of the stress polygon model are plotted as a closed region (stress polygon constraint region), and the constraint conditions of the wellbore wall failure model are plotted as boundary curves. After superimposing the two graphs, grid processing is performed (grid density: 0.1 MPa×0.1 MPa), and the point set in the intersection region satisfying both constraint conditions is extracted to obtain the multi-source coupling constraint principal stress interval, with the interval boundaries accurate to 0.1 MPa. During this process, the measured wellbore wall failure angle θ (obtained through wellbore wall image analysis in step S1) is substituted into the calculation, and the wellbore wall radius is taken as the standard size of 83.3 mm, ultimately intervals of the multi-source coupling constraint principal stress are obtained.
Step S5: performing a strength constitutive constraint principal stress based on the failure type by using the uniaxial compressive strength value and the tensile strength value.

In the embodiment of the present application, the failure type is first determined by the wellbore wall failure information obtained from the failure identification module. When the failure type is caving, the uniaxial compressive strength value measured by the mechanical testing module is applied to the shear failure criterion, i.e., the calculation formula

$${σ}_{1}^{′} = {σ}_{c} + {tan}^{2} ( 45 ° + \frac{φ}{2} ) {σ}_{3}^{′}$$

is used, φ is the core internal friction angle with a value range of 25° to 35°, and different core types take different fixed values. Each point (Sₕ, S_{H}) in the multi-source coupling constraint principal stress interval is substituted into this formula for verification. When the combination of Sₕ and S_{H} satisfies the condition

$${σ}_{1}^{′} = {σ}_{c} + {tan}^{2} ( 45 ° + \frac{φ}{2} ) {σ}_{3}^{′} ,$$

the point is marked as a feasible solution; otherwise, it is marked as an infeasible solution, thereby forming the distribution of feasible and infeasible solution regions. Subsequently, the infeasible solution regions are eliminated to obtain the strength constitutive constraint principal stress interval that satisfies the core shear limit conditions. When the failure type is induced tensile fractures, the system performs thermal stress disturbance analysis to calculate the additional tensile stress generated during the cooling process. The calculation formula is

$${σ}_{T} = α E \frac{{T}_{2} - {T}_{1}}{1 - v} ,$$

where α is the thermal expansion coefficient (with a value range of 8×10⁻⁶ to 12×10⁻⁶ K⁻¹, E is Young's modulus, T₂ and T₁ are the original temperature and post-cooling temperature of the core, respectively, with a temperature difference generally of 10 to 30 degrees Celsius, and ν is Poisson's ratio. The additional tensile stress value and the tensile strength value Sₜ measured by the mechanical testing module are jointly applied to the tensile failure criterion

$${σ}_{3}^{′} = - {S}_{t}$$

to modify the boundaries of the original multi-source coupling constraint principal stress interval, to obtain a more accurate strength constitutive constraint principal stress interval. The system transmits the modified strength constitutive constraint principal stress interval to the intersection inversion module for regional overlap determination with the difference between the maximum and minimum stresses.
Step S6: performing topological visualization on the multi-source coupling constraint principal stress and the strength constitutive constraint principal stress, and regionally overlapping the difference between the maximum stress and the minimum stress and a topological visualization result to determine a numerical range of a maximum principal stress and a minimum principal stress.

In the embodiment of the present application, the intersection inversion module first converts the difference ΔS between the maximum and minimum stresses obtained from the DCDA experiment by the stress difference measurement module into a stress difference constraint line, expressed as Sₘₐₓ=Sₘᵢₙ+ΔS, where Sₘₐₓ is the maximum principal stress and Sₘᵢₙ is the minimum principal stress. This constraint line appears as a straight line with a constant slope of 1 on a two-dimensional plane. The intersection inversion module then creates a standard two-dimensional Cartesian coordinate system, defining the abscissa as the minimum principal stress (ranging from 10 MPa to 100 MPa) and the ordinate as the maximum principal stress (ranging from 20 MPa to 150 MPa). Subsequently, the multi-source coupling constraint principal stress interval (represented as a closed polygonal region in the coordinate system) and the strength constitutive constraint principal stress interval (representing further restrictions on the polygonal region) are plotted on this coordinate system. Meanwhile, the stress difference constraint line Sₘₐₓ=Sₘᵢₙ+ΔS is overlaid to the same coordinate system to form a complete topological visualization map of caving/induced tensile fractures. The intersection inversion module identifies the precise coordinates of the intersection points between the stress difference constraint line and the boundaries of the constrained regions through numerical calculations. When there are two discrete intersection points, the line segment between them represents the reasonable stress value interval, where each point (Sₕ,S_{H}) satisfies the stress difference constraint, stress polygon constraint, wellbore wall failure constraint, and strength constitutive constraint conditions. When there is a single intersection point, this point is the exact stress solution, denoted as (Sₕ₀,S_{H0}). For practical cases, such as a well in an oilfield at a depth of 2500 meters, the topological visualization analysis using this method shows that the minimum principal stress ranges from 45.7 MPa to 52.3 MPa, the maximum principal stress ranges from 68.2 MPa to 74.8 MPa, the vertical stress is fixed at 67.5 MPa, and the stress difference is 22.5 MPa, thereby determining the complete three-dimensional in-situ stress state at this depth.

The present application improves the accuracy and adaptability of in-situ stress determination by systematization, multi-source fusion, and has significant beneficial effect. Firstly, the wellbore wall failure information is fully utilized to improve the ability to identify the formation stress state, and the problem of low utilization rate of wellbore wall information in the traditional method is avoided. Secondly, the representativeness of the samples is enhanced by the selection and comparative analysis of multiple types of core samples, so as to improve the reliability of the experimental data. Combined with the Diameter Core Deformation Analysis (DCDA), the difference between the maximum and minimum stress is extracted, which effectively avoids the problem of large error in a single measurement method, and is especially suitable for deep structural regions with strong stratigraphic heterogeneity. And the induced stress polygon model and the wellbore wall failure model form a two-dimensional constraint system, and are combined with the constitutive relationship of rock strength value to achieve the deep integration of multi-source data, which greatly improves the accuracy and physical consistency of the principal stress derivation. Finally, the topological visualization method is used to carry out the region overlap analysis, which not only enhances the intuitiveness and interpretability of the stress identification process, but also effectively improves the stability and accuracy of the determination of the maximum principal stress and minimum principal stress range, which provides a more reliable and generalizable technical path for the study of deep in-situ stress.

Preferably, the Step S1 includes:
Step S11: collecting wellbore wall image data of a measurement section through a well-perimeter microresistivity imaging logging tool;
Step S12: performing noise removal and image enhancement on the wellbore wall image data of the measurement section, and extracting the wellbore wall damage information;
Step S13: identifying the failure type based on the wellbore wall failure information, wherein the failure type comprises caving and induced tensile cracks;
Step S14: identifying a core distribution law based on the wellbore wall failure information, and selecting a variety of core samples based on the core distribution law;
Step S15: calculating the overlying pressure parameters of a variety of core samples based on the wellbore wall failure information by a formula:

$${S}_{V} = {\int }_{0}^{H} ρ ( h ) gdh$$

where S_{V} represents the overlying pressure parameters, ρ(h) is a density of a core at depth h, g is a gravitational acceleration, and H is a core depth.

In the embodiment of the present application, the failure identification module uses a STAR-II type borehole surrounding resistivity imaging logging tool. The logging tool is equipped with 8 micro-electrode arms, each arm carries 12 micro-electrodes, totaling 96 measurement points. It performs a 360° omni-directional scan of the measurement interval at a constant pulling rate of 2 cm/s in the well, with a sampling interval of 5 mm, an electrode radial measurement accuracy of 0.1 mm, and an azimuth measurement accuracy of 2°, to obtain high-resolution wellbore wall image data. The collected wellbore wall image data are subjected to digital filtering processing, using a Gaussian filter to eliminate random noise with a filter radius set to 3 pixels. Subsequently, histogram equalization is performed for image enhancement, with the contrast enhancement parameter set to 1.5. The wellbore wall failure information, including the location of fracture zones, fracture width, fracture depth, and azimuth angles, is extracted through a Fullbore Microresistivity Imaging (FMI) image processing workstation to form a wellbore wall failure feature dataset. Based on the wellbore wall failure feature dataset, the failure type is identified. When the wellbore wall exhibits symmetrical fan-shaped failure regions and the azimuth is consistent with the direction of the minimum horizontal principal stress, it is determined as caving. When the wellbore wall exhibits longitudinal axial fractures and the azimuth is consistent with the direction of the maximum horizontal principal stress, it is determined as induced tensile fractures. Key failure feature parameters are recorded. According to the wellbore wall failure information, the core sampling depth and location are determined. Sections with obvious failure phenomena and homogeneous lithology are preferentially selected. At least 5 types of core samples with different lithologies are selected from the measurement interval, including sandstone, mudstone, limestone, shale, and mixed rock, with no fewer than 3 samples for each lithology. The core diameter is uniformly 62.5 mm, and the length is 125 mm to ensure a length-diameter ratio of 2:1. The cores are numbered, and information such as core sampling depth, lithology, color, and density is recorded. Gamma density logging data are used to calculate the core density ρ(h) at the depth of each core sample, with a density measurement accuracy of ±0.01 g/cm³. The core depth H is accurate to ±0.1 m, the gravitational acceleration g is taken as 9.8 m/s², and these values are substituted into the formula

$${S}_{V} = {\int }_{0}^{H} ρ ( h ) gdh$$

for integral calculation. The continuous integral is discretized by the trapezoidal integration method as

$${S}_{V} = {\sum }_{i = 1}^{n} \frac{ρ ( {h}_{i} ) + ρ ( {h}_{i + 1} )}{2 g Δ {h}_{i}} ,$$

Δhᵢ is the thickness of the ith layer, an integration step size is set to 5 m. Finally, the overlying pressure parameter S_{V}(Unit: MPa) is calculated.

Through high-precision image acquisition and an intelligent analysis process, the present application effectively improves the scientificity and pertinence of wellbore wall failure information extraction and core sample selection, with significant beneficial effects. First, the use of micro-resistivity imaging logging technology to obtain high-resolution wellbore wall images enhances the ability to perceive microstructural changes around the borehole, providing a rich data foundation for subsequent analysis. The image processing and enhancement steps improve the recognizability of failure features, making the extraction of wellbore wall failure information more accurate and reliable, and effectively reducing information omissions or misjudgments caused by noise interference. The identification of failure types achieves classification and judgment of typical failure modes such as caving and tensile fractures, providing important prior conditions for subsequent stress state derivation. And through the identification and analysis of core distribution laws, representative core samples can be selected in a targeted manner, significantly improving the adaptability of the samples and the credibility of mechanical parameter testing. In addition, the calculation of overlying pressure parameters in combination with wellbore wall failure information not only improves the accuracy of stress input data but also enhances the characterization capability of the formation vertical stress field, providing an important support for constructing a more reasonable in-situ stress model. Overall, this solution demonstrates good adaptability and engineering application value in complex formation environments.

Preferably, the Step S2 includes:
Step S21: performing physical size inspection and standard shaping on each core sample to obtain a to-be-experimented sample;
Step S22: deploying ultrasonic transducers at both ends of the to-be-experimented sample, longitudinal wave velocity and shear wave velocity are measured respectively, and Poisson's ratio and Young's modulus are calculated;
Step S23: performing a standard uniaxial compression test on the to-be-experimented sample, gradually pressurizing to destroy the to-be-experimented sample, and recording a maximum axial stress value when the to-be-experimented sample is destroyed, that is, a uniaxial compressive strength value;
Step S24: applying a radial compressive load to a core cylindrical sample to the to-be-experimented sample, and calculating the tensile strength value according to a crack load and size of the to-be-experimented sample; and
Step S25: recording the Poisson's ratio, the Young's modulus, the uniaxial compressive strength value and the tensile strength value as rock mechanical parameters.

In the embodiment of the present application, the mechanical testing module first uses an electronic vernier caliper to detect the dimensions of various core samples with a measurement accuracy of 0.01 mm, ensuring that the diameter error of cylindrical core samples does not exceed 0.5 mm and the end surface parallelism deviation does not exceed 0.02 mm. Subsequently, the SHM-200 rock cutting machine is used to cut the core samples into standard cylinders, with the length-diameter ratio strictly controlled within the range of 2.0±0.05, i.e., the length is 125±1 mm and the diameter is 62.5±0.5 mm. After cutting, the end surfaces are finely ground with an abrasive stone to ensure that the surface roughness is less than 0.02 mm, and compressed air is used to thoroughly remove surface rock dust. The processed samples are dried for 24 hours to a constant weight state to prepare the samples for testing. UPV-1500 ultrasonic transducers are installed at both ends of the to-be-experimented sample, the transmitting transducer has a frequency of 100 kHz and the receiving transducer has a sensitivity of −85 dB. A couplant is evenly applied to the contact surface between the transducers and the sample, and a fixed pressure of 10 N is applied to ensure good contact. Ultrasonic waves are emitted and the wave propagation time t is recorded. The longitudinal wave velocity is calculated using the formula

$${V}_{p} = \frac{L}{t} ,$$

where L is the sample length. The transducers' polarization direction is then adjusted to measure the shear wave velocity Vs. Based on the measured wave velocities, Poisson's ratio ν is calculated using the formula

$$= \frac{{V}_{p}^{2} - 2 {V}_{s}^{2}}{2 ( {V}_{p}^{2} - {V}_{s}^{2} )} ,$$

and Young's modulus E is calculated using the formula

$$E = ρ {V}_{s}^{2} \cdot \frac{3 {V}_{p}^{2} - 4 {V}_{s}^{2}}{{V}_{p}^{2} - {V}_{s}^{2}} ,$$

where ρ is the core density. The to-be-experimented sample is placed in an RTR-2000 rock triaxial testing machine with a pressure range of 2000 kN and a loading accuracy of ±0.5%. Uniaxial compression tests are strictly conducted in accordance with ISRM standards, after applying an axial preload of 2 MPa, the displacement sensor is zeroed, and then axial pressure is gradually applied at a constant loading rate of 0.5 MPa/s until the sample fails. The stress-strain curve is recorded throughout the process to determine the maximum axial stress value σ_{c} at sample failure, which is the uniaxial compressive strength value. The RDT-300 Brazilian splitting testing machine is used to perform radial compression on the to-be-experimented sample. The testing machine has a pressure range of 300 kN, and the radial loading rate is controlled at 200 N/s. The sample is split along the cylindrical axis, and the tensile strength value St is calculated using the formula

$${S}_{t} = \frac{2 P}{π DL}$$

based on the failure load, sample diameter, and length. The measured Poisson's ratio ν (dimensionless, with a value range of 0.15-0.45), Young's modulus E (unit: GPa, value range 10-80 GPa), uniaxial compressive strength value (unit: MPa, value range 20-200 MPa), and tensile strength value σ_{c} (unit: MPa, value range 2-20 MPa) form a complete set of rock mechanical parameters. Each parameter is the average of three samples, with the standard deviation controlled within 5%. These parameters are input into the data processing system and transmitted to the stress difference measurement module.

Through standardized core sample preparation and systematic mechanical testing processes, the present application ensures the scientificity, accuracy, and engineering applicability of rock mechanical parameter acquisition, with significant beneficial effects. First, physical dimension inspection and standard shaping effectively improve the geometric consistency and experimental repeatability of samples, avoiding data deviations caused by irregular samples. The introduction of non-destructive ultrasonic testing to accurately obtain longitudinal and shear wave velocities, and thereby calculate Poisson's ratio and Young's modulus, not only improves parameter testing efficiency but also ensures the in-situ representativeness and accuracy of mechanical parameters. The combination of uniaxial compression and radial fracturing tests enables comprehensive determination of compressive and tensile strength values, providing key constitutive parameter support for in-situ stress state inversion. This multi-index linkage mechanical property acquisition system enhances the comprehensiveness and depth of rock mechanical behavior characterization, providing a more solid and reliable physical foundation for stress modeling and boundary constraints, and is particularly suitable for high-precision in-situ stress analysis under complex geological structures and deep formation conditions.

Preferably, the Step S3 includes:
Step S31: marking the smooth core sample from a variety of core samples based on the failure type, and measuring at intervals of 15° to 30° along a circumference of a cross-section of the smooth core sample by a laser displacement meter;
Step S32: recording original diameter distribution data of the smooth core sample in the absence of external force;
Step S33: applying axial pressure to the smooth core sample, wherein the axial pressure is a one-way compression, static load and a loading mode that simulates a deep stress state;
Step S34: measuring a diameter change of the smooth core sample at the same angle again under a condition of applying axial pressure, to obtain deformation radial dimension data; and
Step S35: identifying a direction of a maximum difference and a direction of a minimum difference of the diameter after loading based on the original diameter distribution data and the deformation radial dimension data, and calculating the difference of the maximum stress and minimum stress by a formula:

$$Δ S = {S}_{max} - {S}_{min} = \frac{E}{1 + v} \frac{{d}_{max} - {d}_{min}}{{d}_{0}}$$

where ΔS is the difference between the maximum stress and the minimum stress, Sₘₐₓ is a maximum stress value, Sₘᵢₙ is a minimum stress value, E is the Young's modulus, ν is the Poisson's ratio, dₘₐₓ is a maximum diameter after loading, dₘᵢₙ is a minimum diameter after loading, and d₀ is the original diameter distribution data.

In an embodiment of the present application, cylindrical core samples with intact surfaces, no micro-cracks, and a diameter error of less than 0.02 mm are selected from various core samples analyzed for failure types as smooth core samples. A KEYENCE LK-G5000 series laser displacement meter is used to measure 24 points at fixed intervals of 20° along the circumference of the cross-section of the smooth core sample, with the laser scanning accuracy controlled within 1 micrometer. The smooth core sample is placed in a constant temperature environment (25±0.5 °C), and the original diameter value of each measurement point under no external force is recorded to generate a complete original diameter distribution data table, including the measurement angle and corresponding diameter value (unit: mm, accurate to 0.001 mm). The smooth core sample is installed on the loading platform of an MTS815 hydraulic servo loading system, with an axial loading pressure set to 10 MPa. A unidirectional compressive static load is applied at a constant rate of 0.2 MPa/min for 60 minutes to ensure that the core sample remains within the elastic deformation range. While maintaining the axial pressure constant, the same 24 angular positions are re-measured using the same laser displacement meter to record the radial dimension data after deformation, forming a radial dimension distribution table under the loading state. By comparing the original diameter distribution data with the deformed radial dimension data, the diameter change amount at each angular position is calculated. A polar coordinate diagram is used to plot the change amount distribution curve to determine the angular direction with the maximum change amount (referred to as the maximum deformation direction α) and the angular direction with the minimum change amount (referred to as the minimum deformation direction β). The corresponding maximum diameter value dₘₐₓ (post-deformation maximum diameter, unit: mm) and minimum diameter value dₘᵢₙ (post-deformation minimum diameter, unit: mm) are extracted. Combined with Young's modulus E (unit: GPa, requiring conversion to MPa) and Poisson's ratio ν (dimensionless), these values are substituted into a formula

$$Δ S = {S}_{max} - {S}_{min} = \frac{E}{1 + v} \frac{{d}_{max} - {d}_{min}}{{d}_{0}}$$

to calculate the difference ΔS between the maximum and minimum stresses (unit: MPa), where d₀ is the average original diameter (unit: mm). Unit consistency is ensured during the calculation process, and finally, the difference between the maximum and minimum stresses is obtained with a precision of 0.1 MPa, and this difference directly reflects the magnitude of the principal stress difference in the surrounding rock stress field.

The present application effectively improves the accuracy and physical interpretability of obtaining the difference between the maximum and minimum principal stresses through high-precision deformation measurements of smooth core samples under different loading states, offering prominent beneficial effects. Firstly, screening smooth core samples based on failure types ensures the structural integrity and isotropy of the samples, providing an ideal physical foundation for subsequent measurements. The use of a laser displacement meter to conduct detailed measurements at multiple angles around the circumference of the sample not only improves the spatial resolution of radial deformation data but also significantly enhances the sensitivity and accuracy of stress difference derivation. By comparing the radial dimension changes before and after loading, the stress response differences of materials in different directions can be intuitively reflected, enabling accurate identification of the maximum and minimum deformation directions and thereby deriving the principal stress difference. This method not only avoids the high dependence of traditional pressure measurement methods on complex boundary conditions but also circumvents error interference caused by formation heterogeneity, making it particularly suitable for fine stress inversion in deep and complex stress environments. Overall, this solution has advantages such as strong non-destructiveness, high measurement accuracy, and strong result interpretability, serving as an important technical means for quantitative evaluation of in-situ stress.

Preferably, the constructing the stress polygon model based on the overlying pressure parameters in the Step S4 includes:
constructing the stress polygon model including:

$$\frac{{S}_{V} - {P}_{P}}{{S}_{h} - {P}_{P}} \leq {[ {( {μ}^{2} + 1 )}^{\frac{1}{2}} + μ ]}^{2}$$

$$\frac{{S}_{H} - {P}_{P}}{{S}_{h} - {P}_{P}} \leq {[ {( {μ}^{2} + 1 )}^{\frac{1}{2}} + μ ]}^{2}$$

$$\frac{{S}_{H} - {P}_{P}}{{S}_{V} - {P}_{P}} \leq {[ {( {μ}^{2} + 1 )}^{\frac{1}{2}} + μ ]}^{2}$$

wherein μ is a friction coefficient, a value range is between 0.6~1, dimensionless, S_{V} is the overlying pressure parameters, approximately equal to a longitudinal stress, S_{H} is the maximum principal stress, and Sₕ is the minimum principal stress, and P_{P} is a pore pressure

In an embodiment of the present application, first, a Repeat Formation Tester (RFT) is used to perform in-situ pore pressure measurements in the measurement interval. The pressure sensor of the tester has a sensitivity of 0.01 MPa. Pore pressure data at least 20 depth points are collected at 5-meter intervals. After the measurement, the arithmetic mean value is taken as the representative pore pressure of the measurement interval, accurate to 0.1 MPa. Subsequently, combined with overlying pressure parameters and the friction sliding equilibrium principle in Anderson's fault theory, three inequality relationships of the stress polygon are established.

$$\frac{{S}_{V} - {P}_{P}}{{S}_{h} - {P}_{P}} \leq {[ {( {μ}^{2} + 1 )}^{\frac{1}{2}} + μ ]}^{2}$$

$$\frac{{S}_{H} - {P}_{P}}{{S}_{h} - {P}_{P}} \leq {[ {( {μ}^{2} + 1 )}^{\frac{1}{2}} + μ ]}^{2}$$

$$\frac{{S}_{H} - {P}_{P}}{{S}_{V} - {P}_{P}} \leq {[ {( {μ}^{2} + 1 )}^{\frac{1}{2}} + μ ]}^{2}$$

In this embodiment of the present application, the friction coefficient μ is determined based on the lithological characteristics of the measurement interval: 0.65 for sandstone intervals, 0.85 for mudstone intervals, and 0.75 for limestone intervals. Next, a stress polygon is constructed in a two-dimensional Cartesian coordinate system, where the horizontal axis represents the minimum horizontal principal stress Sₕ and the vertical axis represents the maximum horizontal principal stress S_{H}. The three inequalities are respectively transformed into three boundary lines on the coordinate plane, and the closed region enclosed by these three boundary lines and the straight line where S_{H} is greater than or equal to Sₕ is taken as the stress polygon constraint region. This region represents all theoretically possible value ranges for the maximum principal stress S_{H} and the minimum principal stress Sₕ under the friction-sliding equilibrium condition. For example verification at a specific depth of 2500 meters, with the overlying pressure parameter S_{V}=62.3 MPa, pore pressure P_{P}=25.7 MPa, and taking μ=0.75, the vertex coordinates of the stress polygon region are (30.5 MPa, 48.9 MPa), (30.5 MPa, 86.2 MPa), (48.9 MPa, 86.2 MPa), and (48.9 MPa, 48.9 MPa), forming a trapezoidal stress polygon region. Finally, the position of the overlying pressure value at the current depth is marked on the stress polygon diagram, and the stress polygon region is gridded with a grid size of 0.5 MPa×0.5 MPa. The completed stress polygon model data is stored in a relational array, containing numerical pairs of maximum and minimum principal stresses corresponding to each grid point.

The present application effectively improves the accuracy and operability of in-situ stress state inversion through a method of constructing stress polygon models based on overlying pressure parameters. Firstly, the Repeat Formation Tester (RFT) collects pore pressure data in the measurement interval, providing more realistic and reliable input data for the model and avoiding the problems of insufficient pore pressure data or large deviations in traditional methods. The stress polygon model uses the friction coefficient as an adjustment parameter, which can adjust the relationship between stresses according to the actual frictional properties of the formation, enhancing the model's adaptability and accuracy. Through the setting of constraint conditions, the model systematically balances the interaction between the maximum principal stress, minimum principal stress, and vertical stress, thereby providing a more reasonable prediction of stress distribution. This method is particularly suitable for stress analysis in complex geological conditions, as it comprehensively considers important geological factors such as overlying pressure and pore pressure, reducing the deviations caused by ignoring these factors in traditional models, with strong engineering application value, especially in stress analysis of deep formations and complex structural regions, enabling more accurate inversion of stress states.

Preferably, constructing the wellbore wall failure model based on the failure type includes:
the wellbore wall failure model based on the failure type in the Step S4 including:

$${σ}_{r}^{′} = {P}_{W} - {P}_{P}$$

$${σ}_{θ}^{′} = {σ}_{xx} + {σ}_{yy} - 2 ( {σ}_{xx} - {σ}_{yy} ) cos 2 θ - 4 {τ}_{x y} sin 2 θ - {P}_{W} - {P}_{P}$$

$${σ}_{z}^{′} = {σ}_{z z} - v [ 2 ( {σ}_{xx} - {σ}_{yy} ) cos 2 θ + 4 {τ}_{x y} sin 2 θ ] - {P}_{P}$$

$${τ}_{θ z} = 2 ( - {τ}_{x z} sin θ + {τ}_{y z} cos θ )$$

$${τ}_{r θ} = 0$$

$${τ}_{rz} = 0$$

where

$${σ}_{r}^{′} , {σ}_{θ}^{′} , {σ}_{z}^{′} , {σ}_{θ z} , {σ}_{r θ} , {σ}_{rz}$$

are effective stresses around the wellbore wall in a cylindrical coordinate system, σₓₓ, σ_{yy}, σ_{zz}, τ_{xy}, τ_{xz}, τ_{yz} are variables of an in-situ stress field in a Cartesian coordinate system, P_{W} is a drilling fluid pressure, P_{P} is the hole pressure, ν is the Poisson's ratio, and θ is a failure angle of the wellbore wall;
selecting a corresponding failure criterion based on the failure type;
if the failure type is caving, selecting a shear failure criterion:

$${σ}_{1}^{′} = {σ}_{c} + {tan}^{2} ( 45 ° + \frac{φ}{2} ) {σ}_{3}^{′} ;$$

if the failure type is induced tensile fracture, selecting the tensile failure criterion:

$${σ}_{3}^{′} = - {S}_{t} ;$$

where

$${σ}_{3}^{′}$$

is the minimum effective principle stress,

$${σ}_{1}^{′}$$

is the maximum effective principal stress, σ_{c} is uniaxial compressive strength value, φ is an internal friction angle, Sₜ is a tensile strength value; and
calculating the circumferential and radial stresses of the wellbore wall to determine whether exceeding the range of core failure intensity according to the effective stress around the wellbore wall under the cylindrical coordinate system, the drilling fluid pressure and the pore pressure.

In embodiments of the present application, when the caving failure type is identified, the system calculates the effective stress distribution around the wellbore using the transformation formula from a regular hexahedron Cartesian coordinate system to a cylindrical coordinate system. Specifically,

$${σ}_{r}^{′} = {P}_{W} - {P}_{P}$$

$${σ}_{θ}^{′} = σ + {σ}_{yy} - 2 ( {σ}_{xx} - {σ}_{yy} ) cos 2 θ - 4 {τ}_{x y} sin 2 θ - {P}_{W} - {P}_{P}$$

$${σ}_{z}^{′} = {σ}_{z z} - v [ 2 ( {σ}_{xx} - {σ}_{yy} ) cos 2 θ + 4 {τ}_{x y} sin 2 θ ] - {P}_{P}$$

$${τ}_{θ z} = 2 ( - {τ}_{x z} sin θ + {τ}_{y z} cos θ )$$

$${τ}_{r θ} = 0$$

$${τ}_{rz} = 0$$

For the caving failure type, the shear failure criterion

$${σ}_{1}^{′} = {σ}_{c} + {tan}^{2} ( 45 ° + \frac{φ}{2} ) {σ}_{3}^{′}$$

is applied. Poisson's ratio and Young's modulus measured through DCDA experiments are substituted into the formula to calculate the circumferential stress around the wellbore wall, which is then compared with the uniaxial compressive strength value to determine whether shear failure occurs. For the induced tensile fracture failure type, the tensile failure criterion

$${σ}_{3}^{′} = - {S}_{t}$$

is applied. Poisson's ratio and Young's modulus measured through DCDA experiments are substituted into the formula to calculate the minimum effective principal stress around the wellbore wall, which is compared with the tensile strength value to determine whether tensile failure occurs. Subsequently, the system combines the calculated results of wellbore wall effective stress with the constraint conditions of the stress polygon model to plot a closed region in a two-dimensional coordinate system, where the horizontal axis represents the numerical range of the minimum principal stress Sₕ and the vertical axis represents the numerical range of the maximum principal stress S_{H}. When the failure type is caving, the stress conditions restricted by the shear failure criterion are superimposed onto the stress polygon constraint region based on the calculation results of radial effective stress

$${σ}_{r}^{′} ,$$

circumferential effective stress

$${σ}_{θ}^{′} ,$$

axial effective stress

$${σ}_{z}^{′} ,$$

and tangential stress τ_{θ}_{_{z}}. When the failure type is induced tensile fractures, the stress conditions restricted by the tensile failure criterion are superimposed onto the stress polygon constraint region based on the calculation results of radial effective stress

$${σ}_{r}^{′} ,$$

circumferential effective stress

$${σ}_{θ}^{′} ,$$

axial effective stress

$${σ}_{z}^{′} ,$$

and tangential stress τ_{θ}_{_{z}}. For the additional boundary lines formed after superposition, an intersection region extraction operation is performed to obtain a multi-source coupling constraint principal stress interval that simultaneously satisfies both the stress polygon constraints and the wellbore wall failure model constraints. Each combination of stress values in this interval represents a set of potential in-situ stress solutions, which are used for subsequent overlap determination with the maximum-minimum stress difference to finally determine the precise numerical range of the maximum principal stress S_{H} and minimum principal stress Sₕ.

The present application's method of constructing a wellbore wall failure model based on failure types can effectively improve the accuracy and reliability of wellbore wall stress analysis, particularly suitable for stress evaluation under complex formation conditions. By calculating the effective stress around the wellbore wall in cylindrical coordinates and combining drilling fluid pressure with pore pressure, the model provides a comprehensive characterization of wellbore wall failure states and can accurately identify stress changes caused by different failure types (such as cavings or induced tensile fractures). The use of shear and tensile failure criteria, combined with actual failure types, ensures the scientific validity of the failure mechanism and the model's adaptability. Additionally, by systematically calculating the circumferential and radial stresses of the wellbore wall and comparing them with the failure strength range of core samples, the model can predict in advance whether wellbore wall failure will occur, significantly enhancing the practicality and forward-looking nature of wellbore wall stability analysis. This method accurately considers stress distribution in different directions and its correlation with rock mass mechanical properties, helping optimize drilling operations and ensure wellbore wall safety in complex geological environments, thereby improving the success rate of drilling operations and reducing operational risks.

Preferably, in the Step S4, using a stress polygon model and the wellbore wall failure model to plan a two-dimensional constraint region, and performing a multi-source coupling constraint principal stress comprises:

drawing the numerical range of the maximum principal stress S_{H} and the minimum principal stress Sₕ that meet constraints of the stress polygon model as a closed region in two-dimensional coordinates, to obtain a stress polygon constraint region, where the horizontal axis is the minimum principal stress Sₕ′, the longitudinal axis is the maximum principal stress S_{H}:

selecting a corresponding wellbore wall failure model for regional superposition based on the failure type;
if the failure type is caving, superimposing the wellbore wall failure model limited by the shear failure criterion into the stress polygon constraint region;
if the failure type is induced tensile fracture, superimposing the wellbore wall failure model limited by the tensile failure criterion into the stress polygon constraint region;
after superimposing, forming an additional boundary line to obtain a two-dimensional constraint region; and
analyzing the two-dimensional constraint region by superimposed region, and extracting an intersection region to obtain the principal stress interval of the multi-source coupling constraint.

In an embodiment of the present invention, first, based on the overlying pressure parameter S_{V} and combined with the pore pressure P_{P}, after three repeated measurements at the same depth interval using a pressure penetration tester, the average value is taken to ensure that the error of the pressure data does not exceed ±0.05 MPa. Then, according to the range of the formation friction coefficient μ (valued between 0.6 and 1.0 with a step size not exceeding 0.05), the following mathematical expressions are used to construct the boundaries of a two-dimensional stress polygon:

$${σ}_{H} \leq \frac{{σ}_{v} - {σ}_{P}}{1 - μ} {P}_{P} ,$$

σₕ≥(σ_{ν}−P_{P})·(1−μ)+P_{P}, where σ_{H} is the maximum principal stress, σₕ is the minimum principal stress. By setting σ_{H} as the vertical axis and σₕ as the horizontal axis, continuous boundary curves are plotted on a two-dimensional coordinate graph, to form a closed region. Subsequently, the shear failure boundary (when the failure type is caving) or the tensile failure boundary (when the failure type is induced tensile fracture) output by the wellbore wall failure model is invoked. The boundary line data is superimposed onto the stress polygon constraint region at the same coordinate axis scale, with the coordinate system unit in MPa and the precision controlled to 0.1 MPa. Taking the caving as an example, the shear failure boundary output by the wellbore wall failure model is calculated from the shear strength envelope expression

$${σ}_{1}^{′} = {σ}_{c} + {tan}^{2} ( 45 ° + \frac{φ}{2} ) {σ}_{3}^{′} ,$$

where φ ranges from 28° to 35°. A set of

$${σ}_{1}^{′} - {σ}_{3}^{′}$$

points satisfying this expression is then generated at each 0.1 MPa step and mapped onto the two-dimensional plane. The overlapping portion of the two region boundaries is the dual-dimensional constraint region. By using a coordinate intersection extraction tool, the data points of the stress polygon constraint region are compared one by one with those of the wellbore wall failure boundary. Only the coordinate points within their numerical intersection range are retained to form a closed region, resulting in the constrained interval of the maximum and minimum principal stresses under the combined action of the formation friction coefficient limitation and the rock failure criterion. This interval serves as the preliminary principal stress result before subsequent strength constitutive constraints.

The present application establishes a dual-dimensional constraint system using the stress polygon model and the wellbore wall failure model and implements a method for multi-source coupling constraint principal stresses, which significantly improves the accuracy and reliability of in-situ stress analysis, particularly in complex geological environments. First, by combining the constraint conditions of the stress polygon model and the wellbore wall failure model, the numerical ranges of the maximum and minimum principal stresses can be fully covered, presented as a closed region in a two-dimensional coordinate system, clearly defining the stress variation range and enhancing the visualization and operability of the stress state. Next, through differential processing of failure types, the wellbore wall failure models corresponding to the shear failure criterion and the tensile failure criterion are respectively superimposed onto the stress polygon constraint region to form a more precise dual-dimensional constraint region. This process not only ensures the tight coupling between the wellbore wall failure strength and the stress state but also effectively restricts the variation range of the principal stresses through the superimposed additional boundary lines, avoiding stress solutions that do not conform to physical and mechanical properties. By performing intersection analysis on the superimposed regions, the principal stress interval under multi-source coupling constraints is extracted, providing a multi-verified result interval for stress inversion. Overall, this method can accurately capture the stress state in deep and complex formations, providing scientific and reliable principal stress solutions, and offering strong technical support for drilling operations, wellbore wall stability analysis, and other engineering decisions.

Preferably, the Step S5 includes:
determining constraint parameters based on the failure type;
if the failure type is caving, determining a core shear limit condition for multi-source coupling constraint principal stress interval obtained by using the shear failure criterion, and taking the uniaxial compressive strength value as a failure constraint parameter;
wherein determination of the core shear limit condition is specifically carried out by substituting each point into a shear failure formula based on rock mechanics parameters and multi-source coupling constraint principal stress interval obtained by using the shear failure criterion, to form a graphical distribution of a feasible solution region and an infeasible solution region, and the infeasible region is removed;
if the failure type is an induced tensile crack, performing a thermal stress disturbance analysis of the multi-source coupling constraint principal stress interval obtained by the tensile failure criterion, and taking the tensile strength value as the failure constraint parameter;
when the core is cooled, calculating the additional tensile stress generated by the wellbore wall wall in the measurement section based on the Poisson's ratio and the Young's modulus, and using an additional tensile stress to correct the multi-source coupling constraint principal stress interval obtained by the tensile failure criterion; and
applying the constraint parameters to the multi-source coupling constraint principal stress interval to obtain the strength constraint principal stress range.

In an embodiment of the present application, based on the obtained multi-source coupling constraint principal stress interval, the stress constraint path is first clarified according to the failure type. If the failure type is caving, the shear failure criterion is used to determine the shear limit conditions for the multi-source coupled constrained principal stress interval. Specifically, the uniaxial compressive strength value (unit: MPa, range limited to 40 MPa to 120 MPa) and the internal friction angle φ (range: 28° to 35°) are used as inputs. The Mohr-Coulomb failure condition expression is employed to perform point-by-point inspection of all principal stress value pairs in the principal stress interval. In the two-dimensional coordinate graph, all data points that do not satisfy the failure condition are eliminated, and only the principal stress value combinations that meet the shear limit are retained to form a strength-constrained region. If the failure type is induced tensile fracture, the maximum tensile stress failure criterion is adopte, combined with the tensile strength value (unit: MPa, range: 2 MPa to 8 MPa), the thermal stress perturbation analysis is carried out. First, the additional tensile stress is calculated using the measured wellbore temperature drop (unit: °C, measured by a temperature cable logging tool with a control accuracy of ±0.1 °C). The additional tensile stress is applied to the direction of the minimum principal stress. After point-by-point superposition and correction in the multi-source coupling constraint principal stress interval, it is determined whether the value is less than the tensile strength value. If the minimum principal stress plus the additional tensile stress is still less than the tensile strength value, the stress pair is regarded as a failure state and excluded. Finally, all principal stress value pairs that satisfy the strength boundary are retained to form a strength constitutive constraint principal stress interval.

The approach of the present application, which determines constraint parameters based on failure types and further modifies the multi-source couplingd constraint principal stress interval, can significantly improve the accuracy and engineering applicability of stress analysis. First, by selecting appropriate constraint parameters according to the failure type such as using the uniaxial compressive strength value as a constraint parameter for cavings and eliminating infeasible solution regions through shear limit condition judgment of core samples, thus the matching between the stress state and the actual material strength is ensured. The determination of limit conditions under the shear failure criterion can effectively avoid stress solutions that do not conform to physical strength, thereby improving the reliability of the results. For the failure type of induced tensile fractures, the multi-source coupling constraint principal stress interval under the tensile failure criterion is modified through thermal stress perturbation analysis. By considering the influence of temperature changes on stress, a more comprehensive and detailed stress analysis of the wellbore wall is ensured. The modification of additional tensile stress enables the stress interval to more accurately reflect stress changes in the actual environment, improving the prediction accuracy of failure risks. This process combines rock mechanics parameters with actual formation conditions. Through fine mechanical model modification, it can provide more accurate predictions and practical technical support for wellbore wall stability in complex formation environments, thereby enhancing the safety and efficiency of drilling operations.

Preferably, the Step S6 includes:
expressing the difference ΔS between the maximum stress and the minimum stress ΔS as a functional relationship line, to obtain a stress difference constraint line with a slope of 1, i.e., Sₘₐₓ=Sₘᵢₙ+ΔS;
constructing a two-dimensional coordinate system, wherein the horizontal axis represents the minimum stress value Smin, and the longitudinal axis represents the maximum stress value Smax;
drawing the stress difference constraint line, the multi-source coupling constraint principal stress interval and the strength constitutive constraint principal stress interval in the two-dimensional coordinate system to obtain a topological visualization graph of caving and induced tensile cracks;
identifying an intersection of a stress difference constraint line and a constraint graph based on the topological visualization graph of caving and induced tensile crack topology, to obtain numerical ranges of the maximum and minimum principal stresses;
if the intersection is an interval, the intersection forms a band; if the intersection point is a single point, then the point is an exact stress solution; otherwise, the intersection is a set of values that satisfy Sₘₐₓ=Sₘᵢₙ+ΔS to (Sₘᵢₙ, Sₘₐₓ), and meets boundary conditions of polygon and strength limit region.

In an embodiment of the present application, first, the difference ΔS between the maximum and minimum principal stresses is expressed as a linear function Sₘₐₓ=Sₘᵢₙ+ΔS, where Sₘₐₓ is the maximum principal stress and Sₘᵢₙ is the minimum principal stress. In a two-dimensional coordinate system with Sₘᵢₙ as the horizontal axis and Sₘₐₓ as the vertical axis, a stress difference constraint line with a slope of 1 and a vertical intercept of ΔS is plotted. The coordinate system is calibrated using a millimeter-level plotter, with the coordinate scale ranging from 0 MPa to 150 MPa and a step size of 1 MPa. Next, the multi-source coupling constraint principal stress interval and the strength constitutive constraint principal stress interval are plotted in the same coordinate system. Both sets of data are principal stress value pairs (Sₘᵢₙ,Sₘₐₓ) stored in table form, with each pair marked in different colors to represent the results of multi-source coupling constraints and strength constraints, respectively. The stress difference constraint line is then introduced into the plotting region, and cross-comparison is performed with the point sets of the two principal stress intervals to filter all data points falling on the line or within the line's zonal interval, forming an overlapping region between the stress difference constraint line (slope=1) and the principal stress intervals. The boundaries of this region are determined by intersection points. If a closed interval is formed at the intersection points, this interval represents the numerical zonal range of the maximum and minimum principal stresses. If only a single point lies at the intersection of the three constraint graphs, this point is the precise stress solution. If multiple discontinuous intersection points exist, all coordinate pairs that satisfy the stress difference relationship and are simultaneously within the two principal stress intervals are extracted in sequence to form a set of valid stress solutions. The final results are saved in drawings for subsequent interpretation and verification.

The present application visualizes the relationship between stress difference constraints, multi-source coupling constraints, and strength constitutive constraints by representing the difference between maximum and minimum principal stresses as a functional line in a two-dimensional coordinate system. This method effectively visualizes the stress states of cavings and induced tensile fractures, helping to intuitively identify the intersection points between the stress difference constraint line and other constraint regions, thereby accurately determining the numerical ranges of the maximum and minimum principal stresses. When the intersection forms a zonal region, it indicates a range of stress values, aiding in understanding stress uncertainty; when the intersection is a single point, it provides a precise stress solution for optimizing engineering decisions. These intersection points ensure that principal stress solutions simultaneously satisfy the boundary conditions of stress polygons and strength constraint regions, leading to more accurate and reliable stress analysis results. The use of this topological visualization not only systematically constrains stress solutions but also improves the predictive capability for principal stress states in deep formations and complex geological environments, providing strong technical support for wellbore wall stability analysis, drilling operation optimization, and engineering safety.

Preferably, the present application further provides a three-dimensional core-based in-situ stress measurement system using multi-source data, which is used to execute the above-mentioned three-dimensional core-based in-situ stress measurement method using multi-source data. The three-dimensional core-based in-situ stress measurement system using multi-source data includes:
a failure identification module, for obtaining wellbore wall failure information, and identifying a failure type in the wellbore wall failure information; selecting multiple segments of core samples based on the wellbore wall failure information, and determining overlying pressure parameters based on the multiple core samples;
a mechanical testing module, for performing rock mechanics experiment on each core sample, to generate rock mechanical parameters, wherein rock mechanical parameters comprise a Poisson's ratio, a Young's modulus, a uniaxial compressive strength value and a tensile strength value;
a stress difference measurement module, for marking a smooth core sample from a variety of core samples based on the failure type, and performing Diameter Core Deformation Analysis (DCDA) experiments on the smooth core sample by the Poisson's ratio and the Young's modulus to obtain a difference between a maximum stress and a minimum stress;
a stress modeling module, for constructing a stress polygon model based on the overlying pressure parameters; constructing a wellbore wall failure model based on the failure type; using a stress polygon model and the wellbore wall failure model to plan a two-dimensional constraint region, and performing a multi-source coupling constraint principal stress;
a range constraint module, for performing a strength constitutive constraint principal stress based on the failure type by using the uniaxial compressive strength value and the tensile strength value; and
an intersection inversion module, for performing topological visualization on the multi-source coupling constraint principal stress and the strength constitutive constraint principal stress, and regionally overlapping the difference between the maximum stress and the minimum stress and a topological visualization result to determine a numerical range of a maximum principal stress and a minimum principal stress.

Therefore, in no aspect should the embodiments be considered restrictive but rather exemplary. The scope of the present invention is not limited by the above description. It is intended to cover all changes that fall within the meaning and scope of the equivalent elements of the application documents.

The above description merely represents specific implementations of the present invention, which enable those skilled in the art to understand or practice the invention. Various modifications to these embodiments will be apparent to those skilled in the art, and the general principles defined herein may be implemented in other embodiments without departing from the spirit or scope of the invention. Therefore, the present invention shall not be limited to the embodiments shown herein but shall comply with the broadest scope consistent with the principles and novel features disclosed herein.

What is claimed is:

1. A three-dimensional core-based in-situ stress measurement method using multi-source data, comprising:
Step S1: obtaining wellbore wall failure information, and identifying a failure type in the wellbore wall failure information; selecting multiple segments of core samples based on the wellbore wall failure information, and determining overlying pressure parameters based on the multiple core samples;
Step S2: performing rock mechanics experiment on each core sample, to generate rock mechanical parameters, wherein rock mechanical parameters comprise a Poisson's ratio, a Young's modulus, a uniaxial compressive strength value and a tensile strength value;
Step S3: marking a smooth core sample from a variety of core samples based on the failure type, and performing Diameter Core Deformation Analysis (DCDA) experiments on the smooth core sample by the Poisson's ratio and the Young's modulus to obtain a difference between a maximum stress and a minimum stress;
Step S4: constructing a stress polygon model based on the overlying pressure parameters; constructing a wellbore wall failure model based on the failure type; using a stress polygon model and the wellbore wall failure model to plan a two-dimensional constraint region, and performing a multi-source coupling constraint principal stress;
Step S5: performing a strength constitutive constraint principal stress based on the failure type by using the uniaxial compressive strength value and the tensile strength value; and
Step S6: performing topological visualization on the multi-source coupling constraint principal stress and the strength constitutive constraint principal stress, and regionally overlapping the difference between the maximum stress and the minimum stress and a topological visualization result to determine a numerical range of a maximum principal stress and a minimum principal stress.

2. The three-dimensional core-based in-situ stress measurement method using multi-source data according to claim 1, wherein the Step S1 comprises:
Step S11: collecting wellbore wall image data of a measurement section through a well-perimeter microresistivity imaging logging tool;
Step S12: performing noise removal and image enhancement on the wellbore wall image data of the measurement section, and extracting the wellbore wall damage information;
Step S13: identifying the failure type based on the wellbore wall failure information, wherein the failure type comprises caving and induced tensile cracks;
Step S14: identifying a core distribution law based on the wellbore wall failure information, and selecting a variety of core samples based on the core distribution law; and
Step S15: calculating the overlying pressure parameters of a variety of core samples based on the wellbore wall failure information by a formula:
$${S}_{V} = {\int }_{0}^{H} ρ ( h ) gdh$$
where S_{V} represents the overlying pressure parameters, ρ(h) is a density of a core at depth h, g is a gravitational acceleration, and H is a core depth.

3. The three-dimensional core-based in-situ stress measurement method using multi-source data according to claim 1, wherein the Step S2 comprises:
Step S21: performing physical size inspection and standard shaping on each core sample to obtain a to-be-experimented sample;
Step S22: deploying ultrasonic transducers at both ends of the to-be-experimented sample, longitudinal wave velocity and shear wave velocity are measured respectively, and Poisson's ratio and Young's modulus are calculated;
Step S23: performing a standard uniaxial compression test on the to-be-experimented sample, gradually pressurizing to destroy the to-be-experimented sample, and recording a maximum axial stress value when the to-be-experimented sample is destroyed, that is, a uniaxial compressive strength value;
Step S24: applying a radial compressive load to a core cylindrical sample to the to-be-experimented sample, and calculating the tensile strength value according to a crack load and size of the to-be-experimented sample; and
Step S25: recording the Poisson's ratio, the Young's modulus, the uniaxial compressive strength value and the tensile strength value as rock mechanical parameters.

4. The three-dimensional core-based in-situ stress measurement method using multi-source data according to claim 1, wherein the Step S3 comprises:
Step S31: marking the smooth core sample from a variety of core samples based on the failure type, and measuring at intervals of 15° to 30° along a circumference of a cross-section of the smooth core sample by a laser displacement meter;
Step S32: recording original diameter distribution data of the smooth core sample in the absence of external force;
Step S33: applying axial pressure to the smooth core sample, wherein the axial pressure is a one-way compression, static load and a loading mode that simulates a deep stress state;
Step S34: measuring a diameter change of the smooth core sample at the same angle again under a condition of applying axial pressure, to obtain deformation radial dimension data; and
Step S35: identifying a direction of a maximum difference and a direction of a minimum difference of the diameter after loading based on the original diameter distribution data and the deformation radial dimension data, and calculating the difference of the maximum stress and minimum stress by a formula:
$$Δ S = {S}_{max} - {S}_{min} = \frac{E}{1 + v} \frac{{d}_{max} - {d}_{min}}{{d}_{0}}$$
where ΔS is the difference between the maximum stress and the minimum stress, Sₘₐₓ is a maximum stress value, Sₘᵢₙ is a minimum stress value, E is the Young's modulus, ν is the Poisson's ratio, dₘₐₓ is a maximum diameter after loading, dₘᵢₙ is a minimum diameter after loading, and d₀ is the original diameter distribution data.

5. The three-dimensional core-based in-situ stress measurement method using multi-source data according to claim 1, wherein constructing the stress polygon model based on the overlying pressure parameters in the Step S4 comprises:
constructing the stress polygon model comprising:
$$\frac{{S}_{V} - {P}_{P}}{{S}_{h} - {P}_{P}} \leq {[ {( {μ}^{2} + 1 )}^{\frac{1}{2}} + μ ]}^{2}$$
$$\frac{{S}_{H} - {P}_{P}}{{S}_{h} - {P}_{P}} \leq {[ {( {μ}^{2} + 1 )}^{\frac{1}{2}} + μ ]}^{2}$$
$$\frac{{S}_{H} - {P}_{P}}{{S}_{V} - {P}_{P}} \leq {[ {( {μ}^{2} + 1 )}^{\frac{1}{2}} + μ ]}^{2}$$
wherein μ is a friction coefficient, a value range is between 0.6~1, dimensionless, S_{V} is the overlying pressure parameters, approximately equal to a longitudinal stress, S_{H} is the maximum principal stress, and Sₕ is the minimum principal stress, and P_{P} is a pore pressure.

6. The three-dimensional core-based in-situ stress measurement method using multi-source data according to claim 1, wherein constructing the wellbore wall failure model based on the failure type comprises:
the wellbore wall failure model based on the failure type in the Step S4 comprising:
$${σ}_{r}^{′} = {P}_{W} - {P}_{P}$$
$${σ}_{θ}^{′} = {σ}_{xx} + {σ}_{yy} - 2 ( {σ}_{xx} - {σ}_{yy} ) cos 2 θ - 4 {τ}_{x y} sin 2 θ - {P}_{W} - {P}_{P}$$
$${σ}_{z}^{′} = {σ}_{z z} - v [ 2 ( {σ}_{xx} - {σ}_{yy} ) cos 2 θ + 4 {τ}_{x y} sin 2 θ ] - {P}_{P}$$
$${τ}_{θ z} = 2 ( - {τ}_{xz} sin θ + {τ}_{y z} cos θ )$$
$${τ}_{r θ} = 0$$
$${τ}_{rz} = 0$$
wherein
$${σ}_{r}^{′} , {σ}_{θ}^{′} , {σ}_{z}^{′} , {τ}_{θ z} , {τ}_{r θ} , {τ}_{rz}$$
are effective stresses around the wellbore wall in a cylindrical coordinate system, σₓₓ, σ_{yy}, σ_{zz}, τ_{xy}, τ_{xz}, τ_{yz} are variables of an in-situ stress field in a Cartesian coordinate system, P_{W} is a drilling fluid pressure, P_{P} is the hole pressure, ν is the Poisson's ratio, and θ is a failure angle of the wellbore wall;
selecting a corresponding failure criterion based on the failure type;
if the failure type is caving, selecting a shear failure criterion:
$${σ}_{1}^{′} = {σ}_{c} + {tan}^{2} [ ( 45 ° + \frac{φ}{2} ) {σ}_{3}^{′} ;$$
if the failure type is induced tensile fracture, selecting the tensile failure criterion:
$${σ}_{3}^{′} = - {S}_{t} ;$$
where
$${σ}_{3}^{′}$$
is the minimum effective principal stress,
$${σ}_{1}^{′}$$
is the maximum effective principal stress, σ_{c} is uniaxial compressive strength value, φ is an internal friction angle, Sₜ is a tensile strength value; and
calculating the circumferential and radial stresses of the wellbore wall to determine whether exceeding the range of core failure intensity according to the effective stress around the wellbore wall under the cylindrical coordinate system, the drilling fluid pressure and the pore pressure.

7. The three-dimensional core-based in-situ stress measurement method using multi-source data according to claim 1, wherein in the Step S4, using a stress polygon model and the wellbore wall failure model to plan a two-dimensional constraint region, and performing a multi-source coupling constraint principal stress comprises:
drawing the numerical range of the maximum principal stress S_{H} and the minimum principal stress Sₕ that meet constraints of the stress polygon model as a closed region in two-dimensional coordinates, to obtain a stress polygon constraint region, where the horizontal axis is the minimum principal stress S_{h′}, the longitudinal axis is the maximum principal stress S_{H}:
selecting a corresponding wellbore wall failure model for regional superposition based on the failure type;
if the failure type is caving, superimposing the wellbore wall failure model limited by the shear failure criterion into the stress polygon constraint region;
if the failure type is induced tensile fracture, superimposing the wellbore wall failure model limited by the tensile failure criterion into the stress polygon constraint region;
after superimposing, forming an additional boundary line to obtain a two-dimensional constraint region; and
analyzing the two-dimensional constraint region by superimposed region, and extracting an intersection region to obtain the principal stress interval of the multi-source coupling constraint.

8. The three-dimensional core-based in-situ stress measurement method using multi-source data according to claim 1, wherein the Step S5 comprises:
determining constraint parameters based on the failure type;
if the failure type is caving, determining a core shear limit condition for multi-source coupling constraint principal stress interval obtained by using the shear failure criterion, and taking the uniaxial compressive strength value as a failure constraint parameter;
wherein determination of the core shear limit condition is specifically carried out by substituting each point into a shear failure formula based on rock mechanics parameters and multi-source coupling constraint principal stress interval obtained by using the shear failure criterion, to form a graphical distribution of a feasible solution region and an infeasible solution region, and the infeasible region is removed;
if the failure type is an induced tensile crack, performing a thermal stress disturbance analysis of the multi-source coupling constraint principal stress interval obtained by the tensile failure criterion, and taking the tensile strength value as the failure constraint parameter;
when the core is cooled, calculating the additional tensile stress generated by the wellbore wall in the measurement section based on the Poisson's ratio and the Young's modulus, and using an additional tensile stress to correct the multi-source coupling constraint principal stress interval obtained by the tensile failure criterion; and
applying the constraint parameters to the multi-source coupling constraint principal stress interval to obtain the strength constraint principal stress range.

9. The three-dimensional core-based in-situ stress measurement method using multi-source data according to claim 1, wherein the Step S6 comprises:
expressing the difference ΔS between the maximum stress and the minimum stress ΔS as a functional relationship line, to obtain a stress difference constraint line with a slope of 1, i.e., Sₘₐₓ=Sₘᵢₙ+ΔS;
constructing a two-dimensional coordinate system, wherein the horizontal axis represents the minimum stress value Sₘᵢₙ, and the longitudinal axis represents the maximum stress value Sₘₐₓ;
drawing the stress difference constraint line, the multi-source coupling constraint principal stress interval and the strength constitutive constraint principal stress interval in the two-dimensional coordinate system to obtain a topological visualization graph of caving and induced tensile cracks;
identifying an intersection of a stress difference constraint line and a constraint graph based on the topological visualization graph of caving and induced tensile crack topology, to obtain numerical ranges of the maximum and minimum principal stresses;
if the intersection is an interval, the intersection forms a band; if the intersection point is a single point, then the point is an exact stress solution; otherwise, the intersection is a set of values that satisfy Sₘₐₓ=Sₘᵢₙ+ΔS to (Sₘᵢₙ,Sₘₐₓ), and meets boundary conditions of polygon and strength limit region.
